(19) United States
(12) Patent Application Publication
(10) Pub. No.: US 2006/0068152 A1
(43) Pub. Date: Mar. 30, 2006

(54) Optical recording medium

(75) Inventors: Hiroshi Shingai, Tokyo (JP); Hideaki Miura, Tokyo (JP); Jiro Yoshinari, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/234,280

(22) Filed: Sep. 26, 2005

(30) Foreign Application Priority Data
Sep. 29, 2004 (JP) 2004-284286

(51) Int. Cl. B32B 3/02

(52) U.S. Cl. 428/64.4

(57) ABSTRACT

An optical recording medium is provided which enables overwriting at high speeds or the value of (λ/NA)/V being 70 or less (where λ is the wavelength of the laser beam, NA is the numerical aperture of the objective lens, and V is the overwrite linear speed), and which also enables overwriting at high speeds even in a next-generation optical recording system typified by a blu-ray disc. The recording layer of the optical recording medium is predominantly composed of at least Sb and Mg.

### BACKGROUND OF THE INVENTION

1. Field of the Invention

The present invention relates to an optical recording medium having a phase-change recording layer.

2. Description of the Related Art

In recent years, an optical recording medium which has a phase-change recording layer to utilize a reversible phase change between the amorphous phase and the crystalline phase is widely known.

As is well known, such a phase-change recording layer of an optical recording medium is formed of, for example, Ge—Te, In—Te, Ge—Te—Se—Sb, Ge—Sb—Te, or Ag—In—Sb—Te. Particularly these days, attention has been focused on a material predominantly containing an SbTe eutectic composition as well as containing Ag, In, or Ge, because of the difference in reflectivity between the amorphous state and the crystalline state is large, and the speed of crystallization can be easily changed depending on the composition of the recording film. The material is used as a recording film material for DVD-RW or the like (e.g., see Japanese Patent Laid-Open Publication No. 2000-322740). On the other hand, in recent years, a phase-change recording film material composed of Sb and Ge has also been suggested (e.g., see Japanese Patent Laid-Open Publications Nos. 2004-195742 and 2004-224041).

Such a phase-change optical recording medium is required for a higher recording speed, and it is thus one of critical issues to reduce the crystallization time of the phase-change material.

In overwriting at higher recording speeds, a laser beam spot passes across a point on the recording film in a shorter period of time, (λ/NA)/V, and thus an amorphous-crystalline phase transition needs to be completed within the time (λ/NA)/V, where λ is the wavelength of the laser beam, NA is the numerical aperture of the objective lens, and V is the overwrite linear speed. For this reason, to cope with recording at high speeds, the crystallization time for the recording film has been reduced by increasing the Sb content in the conventional phase-change recording film material that is predominantly composed of SbTe.

However, this raised a problem that a higher Sb content would worsen the thermal stability of the amorphous state, thereby resulting in deterioration of the recording mark through reading. This problem becomes noticeable when (λ/NA)/V is 70 or less. Therefore, with the SbTe-based material, overwriting was difficult to perform at (λ/NA)/V being 70 or less, for example, at recording speeds greater than that of a 4×DVD-RW drive.

On the other hand, a next-generation optical recording system typified by a blu-ray disc has been suggested which operates at λ=405 nm with an objective lens of NA=0.85. With this disc, since the laser beam spot is smaller than that for DVD, the duration of irradiation with the laser beam is shorter, and the value of (λ/NA)/V is reduced. This raised another problem that a further reduction in crystallization time is required of the phase-change material.

### SUMMARY OF THE INVENTION

In view of the foregoing problems, various exemplary embodiments of this invention provide an optical recording medium which enables overwriting at high speeds or the value of (λ/NA)/V being 70 or less (where λ is the wavelength of the laser beam, NA is the numerical aperture of the objective lens, and V is the overwrite linear speed), and which also enables overwriting at high speeds even in a next-generation optical recording system typified by a blu-ray disc.

As a result of intensive studies, the inventor of the present invention found an optical recording medium which enables overwriting at high speeds or the value of (λ/NA)/V being 70 or less (where λ is the wavelength of the laser beam, NA is the numerical aperture of the objective lens, and V is the overwrite linear speed), and which also enables overwriting at high speeds even in a next-generation optical recording system typified by a blu-ray disc.

In summary, the above-described objectives are achieved by following embodiments of the present invention.

(1) An optical recording medium having a phase-change recording layer which utilizes a reversible phase change between an amorphous phase and a crystalline phase wherein the recording layer is predominantly composed of at least Sb and Mg.

(2) The optical recording medium according to claim 1, wherein the recording layer has a content of 65 or more and 95 or less atomic percent Sb and a content of more than zero and 30 or less atomic percent Mg.

(3) The optical recording medium according to claim 1 or 2, wherein the recording layer also contains at least one of Ge and Ga.

(4) The optical recording medium according to claim 3, wherein the recording layer has a content of more than zero and 30 or less atomic percent Ge or Ga.

The optical recording medium according to the present invention provides advantageous effects that overwriting can be performed at high speeds or the value of (λ/NA)/V being 70 or less (where λ is the wavelength of the laser beam, NA is the numerical aperture of the objective lens, and V is the overwrite linear speed), and overwriting can also be performed at high speeds even in a next-generation optical recording system typified by a blu-ray disc.

### BRIEF DESCRIPTION OF THE DRAWINGS

FIG. 1 is a schematic cross-sectional view showing an optical recording medium according to a first exemplary embodiment of the present invention.

### DETAILED DESCRIPTION OF THE PREFERRED EMBODIMENTS

The optical recording medium according to the present invention has a phase-change recording layer which utilizes reversible phase changes between the amorphous phase and the crystalline phase, the recording layer being predominantly composed of at least Sb and Mg. This configuration enables overwriting at high speeds or the value of (λ/NA)/V being 70 or less (where λ is the wavelength of the laser beam, NA is the numerical aperture of the objective lens, and V is the overwrite linear speed), and also enables overwriting at high speeds even in a next-generation optical recording system typified by a blu-ray disc.

Sb and Mg have at a eutectic point when a composition of Sb:Mg is equal to 86:14 on an atomic percentage basis. The composition of the recording film according to the present invention is characterized by being based on this SbMg eutectic composition. Conventionally, a recording film has been conceived which is based on an SbTe, SbGe, or SbGa eutectic composition. The recording film composition based on the SbMg eutectic composition according to the present invention enables crystallization at high linear speeds and has a good thermal stability in the amorphous state, thereby enabling high speed recording.

According to the present invention, there is no practical limitation to the structure of the optical recording medium except for the composition of the recording layer. For example, an exemplary structure of a typical phase-change optical recording medium includes at least a reflective layer, a dielectric layer, a recording layer, a dielectric layer, and an optically transparent layer, which are sequentially stacked on a substrate. The optical recording medium is irradiated with a read/write laser beam through the transparent layer. It is also possible to employ a structure which is irradiated with a read/write laser beam through the substrate. In this case, a dielectric layer, a recording layer, a dielectric layer, a reflective layer, and finally a protective layer are stacked in that order on the substrate.

In either structure of the medium, the dielectric layer may be made up of a single layer or a plurality of dielectric layers. A dielectric layer may also be provided on both the interfaces of the reflective layer.

Now, the present invention will be described below in more detail with reference to the accompanying drawings in accordance with the exemplary embodiment.

### First Exemplary Embodiment

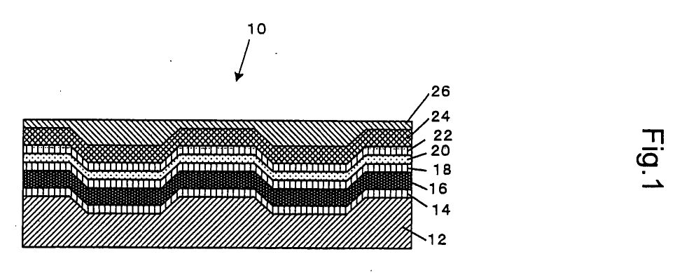

As shown in FIG. 1, an optical recording medium 10 according to the first exemplary embodiment of the present invention includes a substrate 12 of polycarbonate having a thickness of 1.1 mm. On the substrate 12, a first dielectric layer 14, a reflective layer 16, a second dielectric layer 18, a recording layer 20, a third dielectric layer 22, and a heat sink layer 24 are sequentially deposited by sputtering. These layers are entirely crystallized using an initializer, and then an optically transparent layer 26 is finally deposited in a thickness of 0.1 mm.

In this structure, the first dielectric layer 14 was formed of ZrO₂ in a thickness of 5 nm; the reflective layer 16 formed of AgPdCu (Ag:Pd:Cu=98:1:1 on an atomic percentage basis) in a thickness of 10 nm; the second dielectric layer 18 formed of ZrO₂ in a thickness of 4 nm; the third dielectric layer 22 formed of ZrO₂ in a thickness of 5 nm and ZnS—SiO₂ (ZnS:SiO₂=80:20 on a mole percentage basis) in a thickness of 10 nm; and the heat sink layer 24 formed of AIN in a thickness of 40 nm. Additionally, the transparent layer 26 was formed by spin coating using an ultraviolet curable acrylic resin.

In the first exemplary embodiment, as samples of the optical recording medium 10, prepared were 15 types of samples No. 1 to No. 15, in which samples No. 1 to No. 8 and No. 11 to No. 15 were employed as those according to the exemplary embodiment, whereas samples No. 9 and No. 10 were employed as those according to the comparative example.

Table. 1 is showing the relation between the composition of the recording layer 20 of each of samples No. 1 to No. 15 and the linear speed.

TABLE 1

| | | | | | Overwrite |
|---|---|---|---|---|---|
| | Recording film composition | | | | linear |
| Sample | Sb(at %) | Mg(at %) | Ge(at %) | Ga(at %) | speed |
| 1 | 85.0 | 15.0 | 0.0 | — | 29.6 |
| 2 | 80.3 | 19.7 | 0.0 | — | 24.0 |
| 3 | 74.8 | 25.2 | 0.0 | — | 16.2 |
| 4 | 77.1 | 18.0 | 4.9 | — | 15.4 |
| 5 | 79.3 | 12.7 | 8.0 | — | 13.7 |
| 6 | 83.5 | 8.0 | 8.5 | — | 19.5 |
| 7 | 84.3 | 3.8 | 11.9 | — | 17.3 |
| 8 | 85.2 | 1.9 | 12.9 | — | 16.8 |
| 11 | 83.7 | 13.2 | — | 3.1 | 15.3 |
| 12 | 84.7 | 9.2 | — | 6.1 | 11.0 |
| 13 | 77.4 | 19.6 | — | 3.0 | 10.4 |
| 14 | 81.9 | 15.1 | — | 3.0 | 21.0 |
| 15 | 83.4 | 10.7 | — | 5.9 | 13.4 |
| 9(Com- | 100 | 0 | 0 | — | Recording |
| parative | | | | | not |
| example) | | | | | possible |
| 10(Com- | 64.0 | 36.0 | 0.0 | — | Erasing |
| parative | | | | | not |
| example) | | | | | possible |

As shown in Table. 1, the recording layer 20 of samples No. 1 to No. 3, No. 9, and No. 10 is predominantly composed of only Sb and Mg. The recording layer 20 of samples No. 4 to No. 8 also contains Ge in addition to Sb and Mg. The recording layer 20 of samples No. 11 to No. 15 also contains Ga in addition to Sb and Mg. In the first exemplary embodiment, the recording layer 20 has a thickness of 6 nm.

Each of these samples No. 1 to No. 15 was sequentially placed on an optical recording medium evaluation device to perform recording at a laser beam wavelength of 405 nm with NA of 0.85 using a (1, 7) RLL modulated signal as a recording signal. The linear recording and erasing speeds were optimized for each of the samples No. 1 to No. 15.

The inventor of the present invention calculated the maximum overwrite linear speed as follows. That is, while the linear speed is changed, each of data-bearing samples No. 1 to No. 15 was irradiated with a laser beam having a DC erasing power of 3.5 mW in an attempt to erase the data. At this time, measurements were made to the linear speed at which an 8T (T is one clock cycle) signal carrier was erased to a level of 25 dB, thereby obtaining the maximum overwrite linear speed.

As shown in Table. 1, samples No. 1 to No. 8 and samples No. 11 to No. 15 were compatible with an overwrite linear speed of 10 m/s or more; especially, samples No. 1 and No. 2, which are predominantly composed of only Sb and Mg, provided noticeable effects.

On the other hand, for sample No. 9 with a content of 100 atomic percent Sb, which contains no Mg, Ge, and Ga, recording was carried out unsuccessfully. This is conceivably because a content of more than 95 atomic percent Sb would cause the recording layer 20 to be re-crystallized after having been melted due to an excessively high crystallization speed, thereby resulting in the amorphous state being formed (the recording being performed) with difficulty.

On the other hand, for sample No. 10 with contents of 64.0 atomic percent Sb and 36.0 atomic percent Mg, which contains no Ge and Ga, erasing was carried out unsuccessfully. This is conceivably because contents of less than 65 atomic percent Sb and more than 30 atomic percent Mg would cause an excessively low crystallization speed thereby resulting in the amorphous state being changed into the crystalline state (the erasing being performed) with difficulty.

As described above, the optical recording media such as samples No. 1 to No. 8 and samples No. 11 to No. 15, which have the recording layer 20 predominantly composed of Sb and Mg, were successfully overwritten at high speeds of 10 m/s or more. As with samples No. 1 to No. 8 and samples No. 11 to No. 15, Sb and Mg contents are preferably, without limitation, 65 or more and 95 or less atomic percent Sb, and more than zero and 30 or less atomic percent Mg, respectively.

The inventor of the present invention used samples No. 1 to No. 8 and samples No. 11 to No. 15 to record random pattern data at an overwrite linear speed of 10.5 m/s and then measure the amount of jitter. As used in the first exemplary embodiment, the term “jitter” means clock jitter, which was calculated by σ/Tw (where Tw is one clock cycle) after jitter σ of a read signal was determined using a time-interval analyzer. In this experiment, the value of (λ/NA)/V is 45 (=(405 nm/0.85)/10.5 m/s), where λ is the wavelength of the laser beam, NA is the numerical aperture of the objective lens, and V is the overwrite linear speed.

The results of the experiment are shown in Table. 2. Table. 2 shows the relation between the composition of the recording layer 20 of each of the samples No. 1 to No. 8 and samples No. 11 to No. 15 and the amount of jitter caused by recording at an overwrite linear speed of 10.5 m/s.

TABLE 2

| | Recording film composition | | | | Amount of |
|---|---|---|---|---|---|
| Sample | Sb(at %) | Mg(at %) | Ge(at %) | Ga(at %) | jitter |
| 1 | 85.0 | 15.0 | 0.0 | — | Recording not |
| | | | | | possible |
| 2 | 80.3 | 19.7 | 0.0 | — | Recording not |
| | | | | | possible |
| 3 | 74.8 | 25.2 | 0.0 | — | 10.4 |
| 4 | 77.1 | 18.0 | 4.9 | — | 8.1 |
| 5 | 79.3 | 12.7 | 8.0 | — | 8.7 |
| 6 | 83.5 | 8.0 | 8.5 | — | 9.3 |
| 7 | 84.3 | 3.8 | 11.9 | — | 6.7 |
| 8 | 85.2 | 1.9 | 12.9 | — | 16.8 |
| 11 | 83.7 | 13.2 | — | 3.1 | 9.6 |
| 12 | 84.7 | 9.2 | — | 6.1 | 8.2 |
| 13 | 77.4 | 19.6 | — | 3.0 | 9.9 |
| 14 | 81.9 | 15.1 | — | 3.0 | Recording not |
| | | | | | possible |
| 15 | 83.4 | 10.7 | — | 5.9 | 8.2 |

As shown in Table. 2, with samples No. 1, No. 2, and No. 14, the recording was carried out unsuccessfully. This is conceivably because the recording at an overwrite linear speed of 10.5 m/s would cause the recording layer 20 to be re-crystallized after having been melted due to an excessively high crystallization speed of the recording layer 20, thereby resulting in the amorphous state being formed (the recording being performed) with difficulty.

On the other hand, with other samples No. 3 to No. 8, No. 11 to No. 13, and No. 15, a generally favorable amount of jitter was obtained. In particular, with samples No. 4 to No. 7 containing Ge in addition to Sb and Mg, and samples No. 11 to No. 13 and No. 15 containing Ga in addition to Sb and Mg, all the samples provided remarkable amounts of jitter less than 10%. The experiment also showed that samples No. 3 to No. 8, No. 11 to No. 13, and No. 15 caused no degradation in jitter through reading, thus having a high reading durability.

Furthermore, the inventor of the present invention used samples No. 1 to No. 8 and samples No. 11 to No. 15 to record random pattern data at an overwrite linear speed of 15.0 m/s and then measure the amount of jitter. In this experiment, the value of (λ/NA)/V is 32 (=(405 nm/0.85)/15.0 m/s), where λ is the wavelength of the laser beam, NA is the numerical aperture of the objective lens, and V is the overwrite linear speed.

The results of the experiment are shown in Table. 3. Table. 3 shows the relation between the composition of the recording layer 20 of each of the samples No. 1 to No. 8 and samples No. 11 to No. 15 and the amount of jitter caused by recording at an overwrite linear speed of 15.0 m/s.

TABLE 3

| | Recording film composition | | | | Amount of |
|---|---|---|---|---|---|
| Sample | Sb(at %) | Mg(at %) | Ge(at %) | Ga(at %) | jitter |
| 1 | 85.0 | 15.0 | 0.0 | — | Recording not |
| | | | | | possible |
| 2 | 80.3 | 19.7 | 0.0 | — | Recording not |
| | | | | | possible |
| 3 | 74.8 | 25.2 | 0.0 | — | 12.0 |
| 4 | 77.1 | 18.0 | 4.9 | — | 10.4 |
| 5 | 79.3 | 12.7 | 8.0 | — | Erasing not |
| | | | | | possible |
| 6 | 83.5 | 8.0 | 8.5 | — | 11.0 |
| 7 | 84.3 | 3.8 | 11.9 | — | 8.5 |
| 8 | 85.2 | 1.9 | 12.9 | — | 16.8 |
| 11 | 83.7 | 13.2 | — | 3.1 | 10.5 |
| 12 | 84.7 | 9.2 | — | 6.1 | Erasing not |
| | | | | | possible |
| 13 | 77.4 | 19.6 | — | 3.0 | Erasing not |
| | | | | | possible |
| 14 | 81.9 | 15.1 | — | 3.0 | Recording not |
| | | | | | possible |
| 15 | 83.4 | 10.7 | — | 5.9 | Erasing not |
| | | | | | possible |

As shown in Table. 3, with samples No. 1, No. 2, and No. 14, the recording was carried out unsuccessfully as in the case of recording at an overwrite linear speed of 10.5 m/s. This is also conceivably because the recording at an overwrite linear speed of 15.0 m/s would cause the recording layer 20 to be re-crystallized after having been melted due to an excessively high crystallization speed of the recording layer 20, thereby resulting in the amorphous state being formed (the recording being performed) with difficulty.

On the other hand, with samples No. 3, No. 4, No. 6 to No. 11 of the other samples, a generally favorable amount was obtained. Samples No. 5, No. 12, No. 13, and No. 15 were thought to be unable to cope with an overwrite linear speed of 15.0 m/s, thereby resulting in the amorphous state being changed into the crystalline state with difficulty and thus the erasing being performed unsuccessfully.

As described above, the optical recording medium, such as samples No. 4, No. 6, No. 7, and No. 11, which had the recording layer 20 containing at least one of Ge and Ga in addition to Sb and Mg provided a favorable amount of jitter at both the overwrite linear speeds of 10.5 m/s and 15.0 m/s. Since a content of more than 30 atomic percent Ge or Ga would cause a decrease in crystallization speed thereby making erasing difficult to perform, the content is preferably, without limitation, more than zero and 30 or less atomic percent Ge or Ga.

The optical recording medium 10 according to the first exemplary embodiment of the present invention has the recording layer 20 which is predominantly composed of at least Sb and Mg. This arrangement enables overwriting at high speeds or the value of (λ/NA)/V being 70 or less (where λ is the wavelength of the laser beam, NA is the numerical aperture of the objective lens, and V is the overwrite linear speed), and also enables overwriting at high speeds even in a next-generation optical recording system typified by a blu-ray disc.

More specifically, as described above, the optical recording medium 10 according to the first exemplary embodiment enables overwriting both at the values of (λ/NA)/V equal to 45 and 32, where λ is the wavelength of the laser beam, NA is the numerical aperture of the objective lens, and V is the overwrite linear speed.

On the other hand, for DVD-RWs (at the wavelength of the laser beam λ=650 nm with the numerical aperture NA=0.6), the values of (λ/NA)/V (where λ is the wavelength of the laser beam, NA is the numerical aperture of the objective lens, and V is the overwrite linear speed) are 310 for a 1×DVD-RW drive (V=3.5 m/s), 155 for a 2×DVD-RW drive (V=7.0 m/s), 77 for a 4×DVD-RW drive (V=14.0 m/s), 62 for a 5×DVD-RW drive (V=17.5 m/s), and 52 for a 6×DVD-RW drive (V=21.0 m/s). In the case of the blu-ray disc (BD) (at the wavelength of the laser beam λ=405 nm with the numerical aperture NA=0.85), the values of (λ/NA)/V (where λ is the wavelength of the laser beam, NA is the numerical aperture of the objective lens, and V is the overwrite linear speed) are 97 for a 1×BD drive (V=4.9 m/s), 49 for a 2×BD drive (V=9.8 m/s), 24 for a 4×BD drive (V=19.6 m/s), and 16 for a 6×BD drive (V=29.4 m/s).

That is, the optical recording medium 10 according to the first exemplary embodiment enables overwriting generally at a higher recording speed than that of a 4×DVD-RW drive or a 1×BD drive.

To obtain as high an effect as possible, contents of 65 or more and 95 or less atomic percent Sb, and more than zero and 30 or less atomic percent Mg are preferable.

The recording layer 20 also contains at least one of Ge and Ga, thereby providing a favorable amount of jitter. To obtain as high an effect as possible, a content of more than zero and 30 or less atomic percent Ge or Ga are preferable.

The optical recording medium according to the present invention is not limited to the structure or the like of the optical recording medium 10 according to the first exemplary embodiment; for example, the optical recording medium can also take various shapes such as a disc-like, card-like, or sheet-like shape.

The contents of Sb, Mg, Ge, and Ga are not limited to the those of samples No. 1 to No. 15 according to the aforementioned first exemplary embodiment but may be each adjusted as appropriate depending on the overwrite linear speed and amount of jitter to be required.

It is also possible to contain elements other than Sb, Mg, Ge, and Ga.

That is, the optical recording medium according to the present invention is only required to have a phase-change recording layer which utilizes reversible phase changes between the amorphous phase and the crystalline phase, the recording layer being predominantly composed of at least Sb and Mg.

The present invention is applicable, for example, to an optical recording medium having a phase-change recording layer, typified by a DVD-RW or blu-ray disc.

What is claimed is:

1. An optical recording medium having a phase-change recording layer which utilizes a reversible phase change between an amorphous phase and a crystalline phase wherein
the recording layer is predominantly composed of at least Sb and Mg.

2. The optical recording medium according to claim 1, wherein
the recording layer has a content of 65 or more and 95 or less atomic percent Sb and a content of more than zero and 30 or less atomic percent Mg.

3. The optical recording medium according to claim 1, wherein
the recording layer also contains at least one of Ge and Ga.

4. The optical recording medium according to claim 2, wherein
the recording layer also contains at least one of Ge and Ga.

5. The optical recording medium according to claim 3, wherein
the recording layer has a content of more than zero and 30 or less atomic percent Ge or Ga.

6. The optical recoring medium according to claim 4, wherein
the recording layer has a content of more than zero and 30 or less atomic percent Ge or Ga.
